(19) United States
(12) Patent Application Publication
(10) Pub. No.: US 2003/0000464 A1
(43) Pub. Date: Jan. 2, 2003

(54) Rotary application head

(76) Inventor: Wolfgang Puffe, Siegburg (DE)

Correspondence Address: HARNESS, DICKEY & PIERCE, P.L.C., P.O. BOX 828, BLOOMFIELD HILLS, MI, 48303, US

(21) Appl. No.: 10/208,334

(22) Filed: Jul. 30, 2002

Related U.S. Application Data
(63) Continuation of application No. 09/582,421, filed on Aug. 16, 2000, now Pat. No. 6,464,785.

(30) Foreign Application Priority Data
Dec. 22, 1997 (DE) 197 57 238.3
Dec. 22, 1997 (DE) 197 57 237.5

(51) Int. Cl. B05C 5/00

(52) U.S. Cl. 118/301

(57) ABSTRACT

An application head 11 for the contact-free application of hot-melt adhesive to a width of material 22, having a housing 12, having a control slide chamber 20 in the housing 12, in which control slide chamber a cylinder control slide 13 is supported so as to be rotatingly drivable, having at least one supply aperture for introducing an adhesive into the control slide chamber 20, and having a slotted nozzle 18 for releasing the adhesive, which slotted nozzle is controllable by the cylinder control slide 13 and extends transversely to the direction of movement of the width of material 22.

The cylinder control slide 13 comprises a cylindrical surface which is able to seal the slotted nozzle 18 from the inside; it also comprises surface grooves 17 in the cylindrical surface, which, as a function of their rotational positions, are able to communicate with the slotted nozzle.

Furthermore, the cylinder control slide 13, inside the control slide chamber, comprises either an inner cavity 29 which is supplied with medium through the supply aperture, as well as radial exit bores 28 leading from the inner cavity into the surface grooves, or it comprises a helical or spiral-shaped surface groove in the cylindrical surface as well as a storage volume for medium, which communicates with the at least one surface groove.

The invention relates to an application head for the contact-free application of liquid media such as thermoplastic plastics or melted hot-melt adhesives to a width of material which is movable relative to the application head, having a housing, having a control slide chamber in the housing, in which control slide chamber a cylinder control slide is supported so as to be rotatingly drivable, having at least one supply aperture for introducing a medium into the control slide chamber, and having a slotted nozzle for releasing the medium, which slotted nozzle is controllable by the cylinder control slide and extends transversely to the direction of movement of the width of material.

An application head of the above-mentioned type is known from P 197 14 029.7 wherein use is made of a control slide which, in an axial region containing the supply aperture, is provided with a recess which extends over the entire circumference. At least in said axial region it is not possible to arrange an exit nozzle aperture which is controlled by the control slide. This means that, in said axial region, the exit nozzle apertures have to observe an undesirably large distance. In addition, the control slide is relatively short. If it comprised a greater length, it would be necessary to provide a plurality of supply apertures, so that the above-referred problem would occur several times along the slotted nozzle.

From U.S. Pat. No. 5,145,689 it is known to apply adhesive from slotted nozzles on to which there are directed air supply means which lead to swirling of the emerging adhesive threads, whose purpose it is to prevent adhesive threads from tearing off and to prevent the formation of drops which could lead to a non-uniform application of adhesive. Because of the need to supply air, the application heads become complicated and expensive.

Application heads of the above-mentioned type find frequent application in those cases where widths of material have to be laminated on to a substrate. To minimise the specific consumption of liquid medium and, at the same time, to ensure as uniform a distribution of the medium as possible, the medium is applied intermittently to achieve a grid-like application pattern. In order to permit, at the same time, a high transport speed of the width of material, the medium has to be applied in the direction of movement of the width of material at a high frequency, with the grid points extending transversely to the direction of movement of the width of material having to be arranged as closely as possible to one another.

From EP 0 474 155 A2 and EP 0 367 985 A2 there are known application heads in the case of which hole type nozzles are controlled by a pneumatically operated nozzle needle each. When the width of material moves at a high speed, the medium cannot be applied economically because of the limited maximum cycle frequency of the nozzle units, such limitation being the result of the mass inertia of the nozzle needles and of the control elements.

It is therefore the object of the invention to provide an application head of the above-mentioned type which, even if it comprises a great length, is able to achieve an extremely dense application pattern.

The objective is achieved in that the cylinder control slide has the following characteristics:

an inner cavity which can be supplied with medium through the supply aperture,

a cylindrical surface which can seal the slotted nozzle from the inside,

surface grooves in the cylindrical surface which, as a function of their rotational positions, are able to communicate with the slotted nozzle, and

radial exit bores extending from the inner cavity into the surface grooves.

The inventive application head is advantageous in that medium control takes place directly at the slotted nozzle, so that the dispensing accuracy cannot be adversely affected by the toughness of the medium or the elasticity of the medium behind the control region. By supplying the slotted nozzle with medium from the inside of the cylinder control slide it is possible for exit apertures to be arranged across the entire length of the cylinder control slide at, technically, the shortest possible distance without the possibility of any interference. By selecting different shapes of the surface grooves, it is possible to produce different grids and patterns when applying the medium.

According to a first advantageous embodiment it is proposed that the surface grooves comprise a plurality of axis-parallel grooves. If a uniform point grid is to be achieved, it is advantageous to provide a plurality of axis-parallel surface grooves at uniform circumferential distances on the surface of the cyinder control slide. The distances between the grid points in the direction of movement of the width of material can be influenced by changing the rotational speed of the cylinder control slide. If the surface grooves are circumferentially distributed at non-uniform distances, a non-uniform point grid can be produced at a constant driving speed.

On the other hand, if the axis-parallel surface grooves are arranged at uniform circumferential distances, a non-uniform point grid can be achieved by changing the driving speeds of the cylinder control slide. State-of-the-art servomotors for controlling purposes are capable of operating at non-uniform driving speeds.

Grid points extending transversely to the direction of movement of the width of material can be achieved by using, in the slotted nozzle, a suitable nozzle orifice plate with individual bores spaced at short distances. If such a nozzle orifice plate is not provided, the use of axis-parallel grooves leads to a linear application transversely to the direction of movement of the width of material.

According to a second advantageous embodiment, the surface grooves can comprise at least one helical or spiral-shaped groove, as a result of which there occur open regions at the slotted nozzle which, when driving the cylinder control slide in one rotational direction, move along the slotted nozzle so that, if the width of material moves at the same time, there occur application patterns which extend diagonally across the width of material. In this embodiment, it is preferable to use slotted nozzles without nozzle orifice plates, so that said diagonal applications are applied to the width of material in the form of threads. In such a case it can be advantageous to use two application heads arranged one behind the other with oppositely directed surface groove pitches with identical rotational directions of movement or with opposed rotational directions of movement and identical pitches, thereby making it possible to produce on the width of material a pattern of diagonal threads of medium intersecting one another symmetrically.

In one embodiment, the cylinder control slide is provided with at least one journal which axially projects from the housing and in which there is formed an axial bore which is connected to the inner cavity and serves as a supply aperture. This measures makes the housing design particularly simple, but there must be provided a rotating seal in the region of the medium supply means subjected to pressure. According to an alternative embodiment, at at least one end of the housing, there is provided a bore in the housing and an annular channel between the cylinder control slide and the control slide chamber, which annular channel is connected to the bore in the housing, and there are provided radial supply bores in the cylinder control slide in the plane of the annular channel, which are connected to the inner cavity and serve as supply apertures. As a result of this measure, it is possible to simplify the control slide bearing. The medium can be supplied to the housing via simple radial bores. Said annular channel can be formed by an annular groove in the cylinder control slide surface and/or by a circumferential groove in the control slide chamber bore. The annular channel can also be arranged in the region of the end faces of a cylinder control slide being reduced at the journals, in which case the radial supply bores are replaced by axial supply bores in said end faces. Independently of whether supply means are provided at only one end or at both ends of the cylinder control slide, it is possible—for compensating for a slight pressure loss in the medium along the length of the control slide—to slightly increase the diameter of the radial exit bores leading to the grooves. The medium can be prevented from escaping from the housing by using conventional shaft seals.

Furthermore, the objective is achieved by the cylinder control slide having the following characteristics:

a cylindrical surface which can seal the slotted nozzle from the inside,

at least one helical or spiral-shaped surface groove in the cylindrical surface, which, as a function of its rotational position, in certain portions, is able to communicate with the slotted nozzle, as well as

a storage volume for medium inside the control slide chamber, which storage volume communicates with at least one surface groove.

At the points of intersection between the slotted nozzle and the convolution of the spiral-shaped surface groove, the inventive application head generates exit apertures which move in one direction along the nozzle slot when the cylinder control slide rotates. As a result, when the drive of the cylinder control slide rotates and when the width of material is simultaneously driven in the direction of movement, there is produced an infinite number of parallel threads which extend diagonally to the direction of movement of the width of material. In consequence, the medium is applied continuously in the longitudinal direction of the width of material, and the thread thickness can be kept very small. Provided the pitch of the spiral-shaped surface groove is slight and if a plurality of convolutions is provided, it is possible to achieve a very close application pattern. In an advantageous embodiment, it is possible to provide two application heads which are arranged one behind the other and which, if their cylinder control slides are driven in identical rotational directions, comprise oppositely directed surface groove pitches or, if the surface grooves have identical pitches, comprise oppositely directed driving rotational directions of the cylinder control slides. If both application heads are actuated and supplied with medium at the same time, a web of intersecting diagonal threads is formed on the width of material.

According to a first embodiment it is proposed that the control slide chamber, in at least one circumferential region, is widened relative to the cross-section of the cylinder control slide and that the widened cavity between the wall of the control slide chamber and the surface of the cylinder control slide forms the storage volume. This embodiment comprises both a simple housing shape and a simple shape of the solidly produced cylinder control slide. The distances between the individual exit apertures and the storage volume are extremely short and are formed by the individual convolutions of the surface groove.

According to a second embodiment, it is proposed that the cylinder control slide comprises an inner cavity which forms the storage volume and that the control slide chamber surrounds the cylinder control slide substantially sealingly with a cylindrical surface, with the radial bores leading from the inner cavity into the surface groove. The variant described here is advantageous in that the surface groove is radially supplied with medium over an extremely short distance, with the transport of material in the longitudinal direction of the surface groove being eliminated completely. As a result, control precision of the exit apertures is increased. To compensate for any pressure losses along the length of the inner cavity, the size of the radial bores can increase with the distance from the supply point.

In the former embodiment, a housing bore can be connected to the inside of the control slide chamber which forms said supply aperture.

According to a second embodiment, the cylinder control slide can comprise at least one journal which projects from the housing and which is provided with an axial bore which forms the supply aperture leading to the inside of the cylinder control slide.

According to an alternative to the second embodiment, it is proposed that at least one housing bore is connected to an annular channel between the control slide chamber and the cylinder control slide and that radial bores, starting from the annular channel, lead into the inside of the cylinder control slide and form the at least one supply aperture. In this way, first the inside of the cylinder control slide is supplied with medium via the annular channel. From the inside of the cylinder control slide, the medium again enters the surface groove via the radial bores.

Preferred embodiments of the invention will be explained below with reference to the drawings wherein

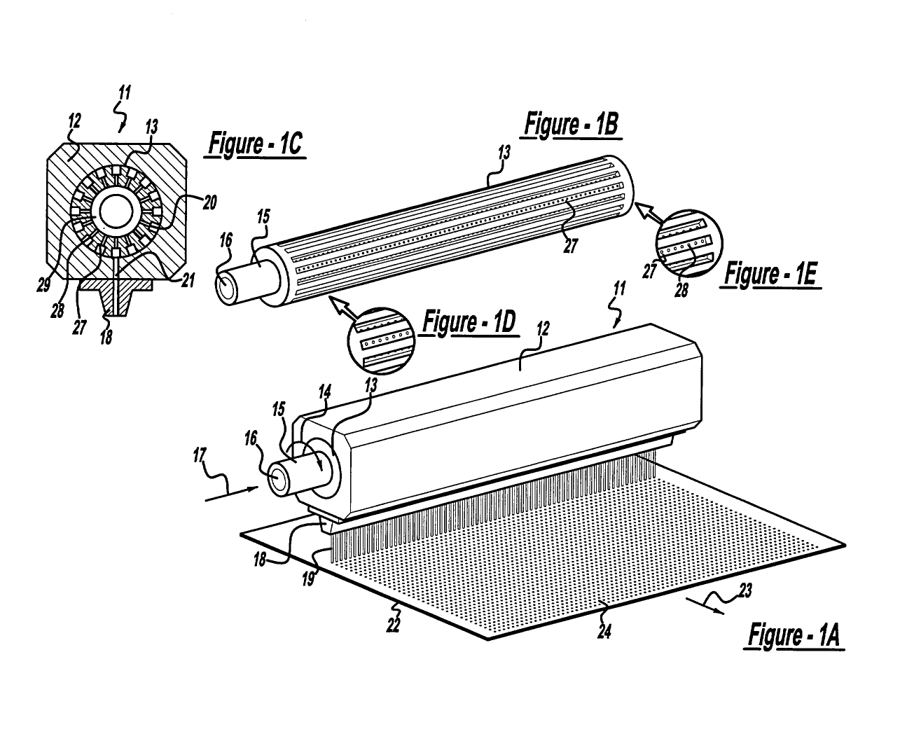

FIG. 1 shows an application head with axis-parallel identically designed surface grooves in the cylinder control slide, with the medium being supplied through a slide journal.

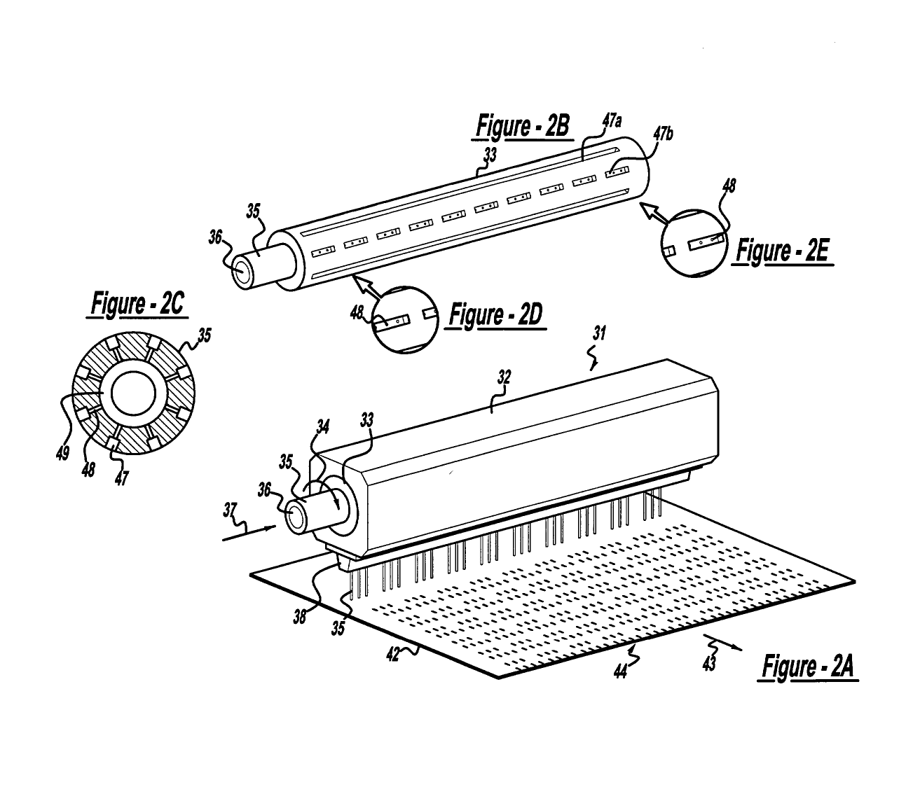

FIG. 2 shows an application head with axis-parallel surface grooves with variable lengths in the cylinder control slide, with the medium being supplied through a slide journal.

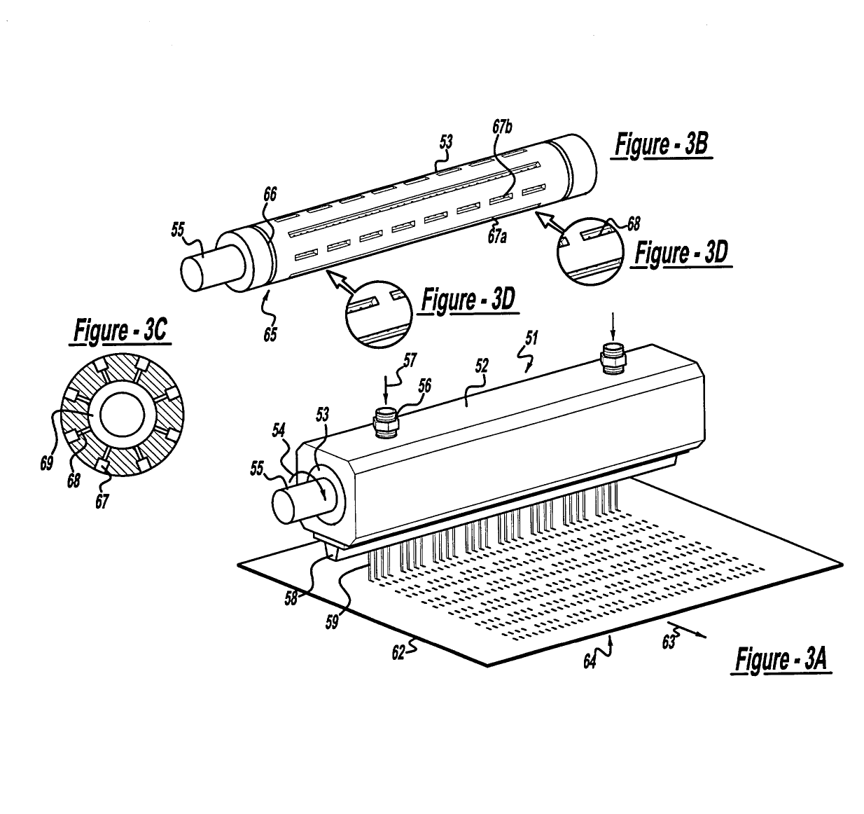

FIG. 3 shows an application head with axis-parallel surface grooves with variable lengths in the cylinder control slide, with the medium being supplied through the housing.

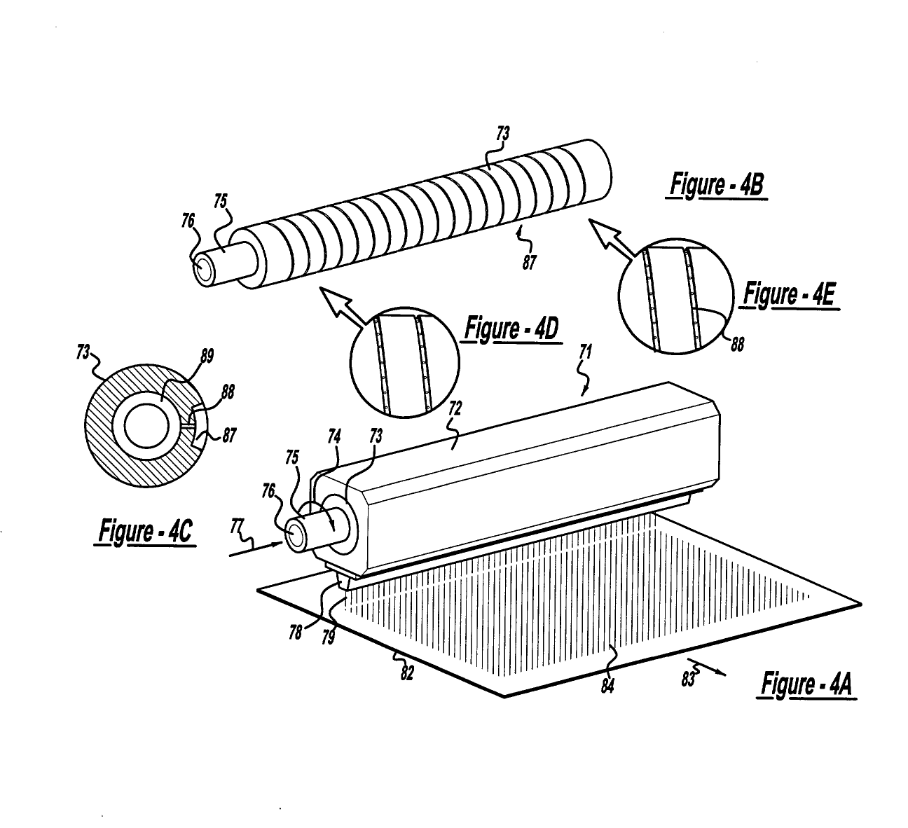

FIG. 4 shows an application head with a cylinder control slide with a spiral-shaped surface groove, with the medium being supplied through a slide journal.

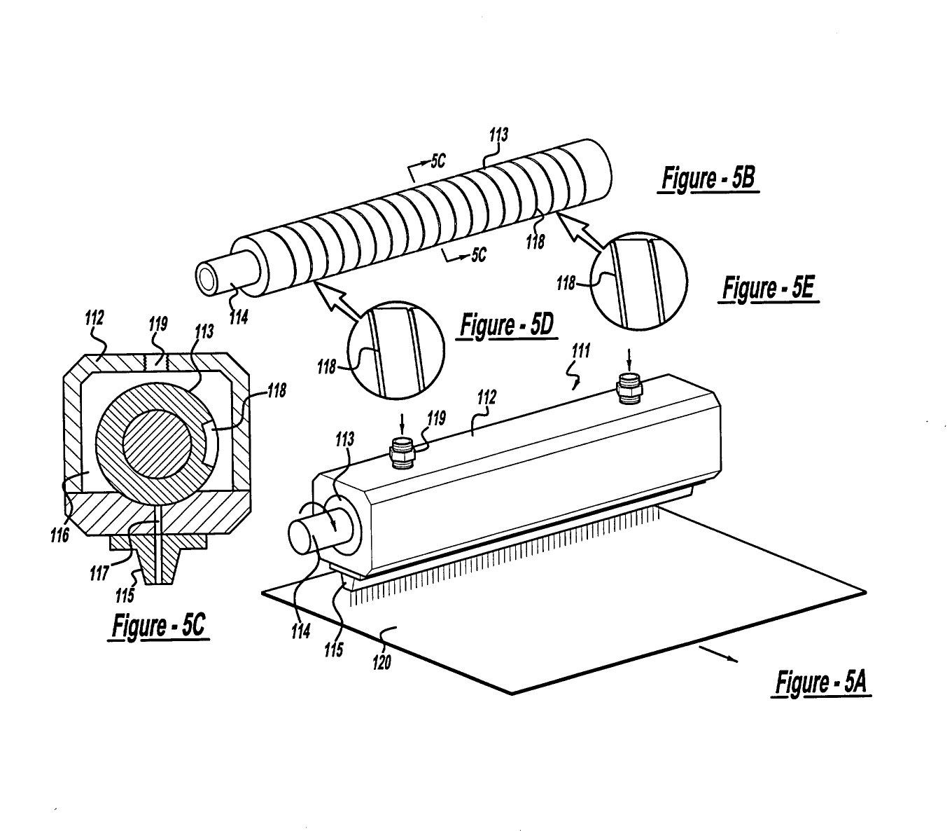

FIG. 5 shows an inventive application head, with the medium being supplied through a widened cavity in the housing.

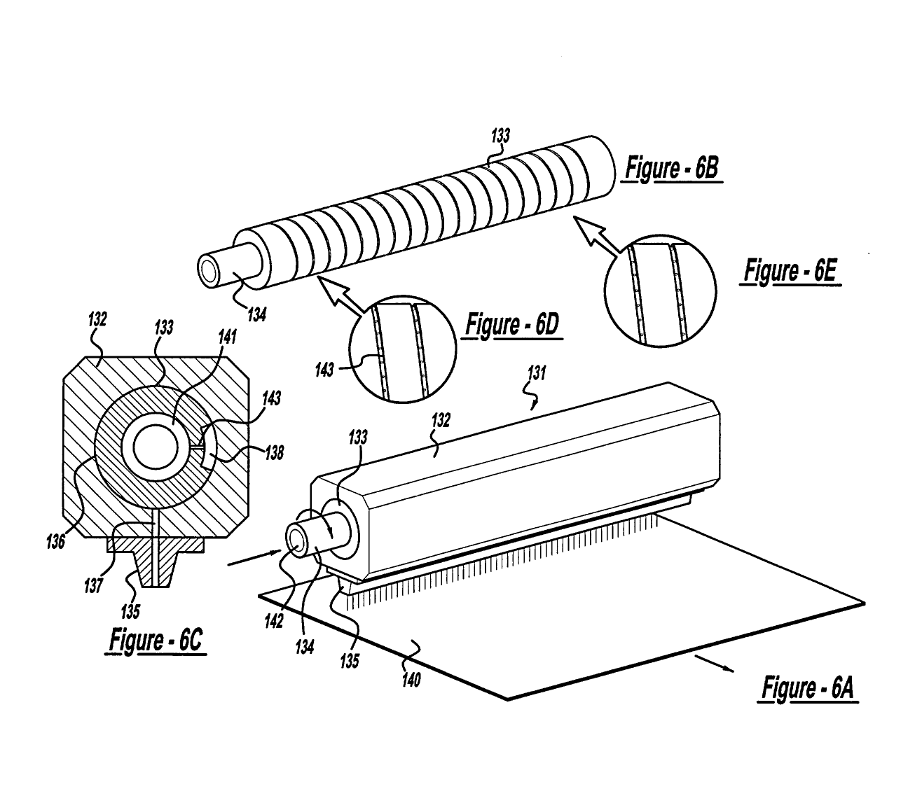

FIG. 6 shows an inventive application head, with the medium being supplied to the spiral-shaped groove through the inside of the cylinder control slide.

FIGS. 1 to 4 show (a) in a perspective view, in the lower part, an application head with a width of material with an application pattern, (b) thereabove, the cylinder control slide as a detail in a perspective view and (c) thereabove again, the housing with a cylinder control slide (FIG. 1) and, respectively, the cylinder control slide on its own (FIGS. 2 to 4) in a cross-section. The perspective illustration of the cylinder control slide in the form of a detail is associated with two enlarged surface regions (d, e).

FIG. 1 shows an application head 11 with an oblong, cubic shape. One end of a cylinder control slide 13 projects from the housing 12 of the application head 11. The direction of rotation of the cylinder control slide 13 is indicated by an arrow 14. The end of the cylinder control slide 13 comprises a journal 15 which is provided with an axial bore 16 through which medium is supplied, as indicated by the arrow 17. Underneath the housing 12, there can be seen a slotted nozzle 18 from which there emerges a spray curtain 19. The spray curtain 19 hits a width of material 22 whose direction of movement is symbolised by an arrow 23. On the width of material 22, the spray curtain 19 generates an application grid 24 which constitutes a square or rectangular point grid. This demonstrates that the slotted nozzle 18 comprises a hole type orifice plate which determines the distance between the grid points extending transversely to the direction of movement of the width of material 22. As can be seen in the detail, the cylinder control slide 13, on its cylindrical surface, is provided with a plurality of axial grooves 27 in which there end radial bores 28. Furthermore, as can be seen in the cross-section, the radial bores 28 are supplied with medium through an inner cavity 29 which forms a storage volume for medium. Via the radial bores 28, the axial grooves 27 are constantly filled with medium. The cylinder control slide can be driven by a servomotor via a journal which is positioned opposite the journal 15 and which can also project from the housing 12. As can be seen in the cross-section, the housing 12 encloses the cylinder control slide 13 by means of a cylindrical control slide chamber 20 from where radial channels 21 lead to the slotted nozzle 18. As shown by the details, the radial bores 28 are smaller in the vicinity of the axial bore 16 than further away.

FIG. 2 shows an application head 31 with an oblong cubic shape. One end of a cylinder control slide 33 projects from the housing 32 of the application head 31. The direction of rotation of the cylinder control slide 33 is indicated by an arrow 34. The end of the cylinder control slide 33 comprises a journal 35 which is provided with an axial bore through which medium is supplied, as indicated by the arrow 37. Underneath the housing 32, there can be seen a slotted nozzle 38 from which there emerges a spray curtain 39. The spray curtain 39 hits the width of material 42 whose direction of movement is symbolised by an arrow 43. On the width of material 42, the spray curtain 38 generates an application grid 44 which constitutes an alternately continuous and interrupted line grid. This demonstrates that the slotted nozzle 38 is provided with a orifice plate which determines the distance between the grid lines extending transversely to the direction of movement of the width of material 42. As can be seen in the detail, the cylinder control slide 33, on its cylindrical surface, comprises a plurality of continuous axial grooves 47a and interrupted axial grooves 47b in which there end radial bores 48. The radial bores 48 are supplied with medium via the axial bore 36 and an inner cavity 49 forming a storage volume for medium. Via the radial bores 48, the axial grooves 47 are constantly filled with medium. The cylinder control slide can be driven by a servomotor via a journal which is positioned opposite the journal 35 and which can also project from the housing 32. In a cross-sectional view, the housing 32 has to be assumed to have the same shape as that shown in FIG. 1. As demonstrated by the details, the radial bores 48 in the vicinity of the axial bore 36 are smaller than those further away.

FIG. 3 shows an application head 51 with an oblong cubic shape. One end of a cylinder control slide 53 projects from the housing 52 of the application head 51. The direction of rotation of the cylinder control slide 53 is indicated by an arrow 54. The housing 52 is provided with two supply muffs 56 via which medium is supplied, as indicated by the arrow 57. Underneath the housing 52, there is shown a slotted nozzle 58 from which there emerges a spray curtain 59. The spray curtain 59 hits a width of material 62 whose direction of movement is symbolised by an arrow 63. On the width of material 62, the spray curtain 58 generates an application grid 64 shows alternately a continuous and an interrupted line pattern. This demonstrates that the slotted nozzle 58 is provided with a orifice plate which determines the distance between the grid lines extending transversely to the direction of movement of the width of material 62. As can be seen in the detail, the cylinder control slide 53, on its cylindrical surface, comprises a plurality of continuous axial grooves 67a and interrupted axial grooves 67b in which there end radial bores 68. The radial bores 68 are supplied with medium via the muffs 56 and through circumferential grooves 65 provided with radial bores 66 and via an inner cavity 69 forming a storage volume for medium. Via the radial bores 68, the axial grooves 67 are constantly filled with medium. The cylinder control slide can be driven by a servomotor via a journal which is positioned opposite the journal 55 and which can also project from the housing 52. In a cross-sectional view, the housing 52 has to be assumed to have the same shape as that shown in FIG. 1.

FIG. 4 shows an application head 71 with an oblong cubic shape. One end of a cylinder control slide 73 projects from the housing 72 of the application head 71. The direction of rotation of the cylinder control slide 73 is indicated by an arrow 74. The end of the cylinder control slide 73 is provided with a journal 75 which is provided with an axial bore 76 through which medium is supplied, as indicated by the arrow 77. Underneath the housing 72, there can be seen a slotted nozzle 78 from which there emerges a spray curtain 79. The spray curtain 79 hits a width of material 82 whose direction of movement is symbolised by an arrow 83. On the width of material 82, the spray curtain 79 generates an application grid 84 which comprises a diagonal parallel line pattern. This demonstrates that the slotted nozzle 78 is provided with a orifice plate which determines the distance between the lines extending transversely to the direction of movement of the width of material 82. As can be seen in the detail, the cylinder control slide 73, on its cylindrical surface, is provided with a helical groove 87 in which there end radial bores 88. The radial bores 88 are supplied with medium via the axial bore 75 and the inner cavity 89 which forms a storage volume for medium. Via the radial bores 88, the helical groove 87 is constantly filled with medium. The cylinder control slide can be driven by a servomotor via a journal which is positioned opposite the journal 75 and which can also project from the housing 72. In a cross-sectional view, the housing 72 has to be assumed to have the same shape as that shown in FIG. 1.

FIGS. 5 and 6 show under a), in the lower part, an application head with a width of material, under b), thereabove, a cylinder control slide in the form of a detail in a perspective view and under c) thereabove, once again a housing with the cylinder control slide in a cross-sectional view. The perspective illustration of the roller gate in the form of a detail is associated with d) and e) showing two enlarged surface regions.

FIG. 5 shows an application head 111 with a housing 112 in which there rotates a cylinder control slide 113 whose journal 114 projects from the front end of the housing 112. A slotted nozzle 115 can be seen underneath the housing 112. As can be seen in the detail, the cylinder control slide 113 comprises a spiral-shaped surface groove 118. The cross-sectional illustration shows that the cylinder control slide 113, at a distance therefrom, is surrounded by a control slide chamber 116 and only in the region of nozzle slot 117, is the cylinder control slide 113 in sealing contact with the surface of said control slide chamber 116. In a circumferential region, the surface groove 118 is shown in section. The control slide chamber 116 is supplied with medium through attaching muffs 119 from where the medium enters the surface groove directly. In the case of driving of the cylinder control slide 113 indicated by a rotary arrow, the sectional regions move between the surface groove 118 and the nozzle slot 117 from left to right along the slotted nozzle 115. From the slotted nozzle 115 there emerges a material curtain of individual threads which, on a width of material 120, during transport, forms a group of adhesive threads extending diagonally relative to the width of material. The direction of movement of the width of material 120 is indicated by an arrow.

FIG. 6 shows an application head 131 with a housing 132 in which there rotates a cylinder control slide 133 whose journal 134 projects from the front end of the housing 132. A slotted nozzle 135 can be seen underneath the housing 132. As can be seen in the detail, the cylinder control slide 133 is provided with a spiral-shaped surface groove 138. As can be seen in the sectional illustration, the cylinder control slide 133 is sealingly enclosed by a cylindrical control slide chamber 136. The cylinder control slide 133 comprises an inner cavity 141 which is supplied with medium through an axial bore 142 in the journal 134, from which inner cavity 141 the medium passes through a plurality of radial bores 143 into the surface groove 138. From there, the medium can emerge through a controlled nozzle slot 117. The size of the radial bores 143 increases with the distance from the medium supply through the axial bore 142 in order to compensate for any pressure decrease in the medium. In a circumferential region, the surface groove 118 is shown in section. In the case of driving of the cylinder control slide 133 indicated by a rotary arrow, the sectional regions between the surface groove 138 and the nozzle slot 117 move from left to right along the slotted nozzle 115. From the slotted nozzle 115 there emerges a material curtain of individual threads which, on the width of material 140, forms a group of adhesive threads extending diagonally relative to said width of material. The direction of movement of the width of material 140 is indicated by the arrow 124.

Rotary application head

| List of reference numbers | |
|---|---|
| 11, 31, 51, 71 | application head |
| 12, 32, 52, 72 | housing |
| 13, 33, 53, 73 | cylinder control slide |
| 14, 34, 54, 74 | arrow |
| 15, 35, 55, 75 | journal |
| 16, 36, —, 76 | axial bore |
| —, —, 56, — | radial muff |
| 17, 37, 57, 77 | arrow |
| 18, 38, 58, 78 | slotted nozzle |
| 19, 39, 59, 79 | spray curtain |
| 20 | control slide chamber |
| 21 | radial channel |
| 22, 42, 62, 82 | material bore |
| 23, 43, 63, 83 | arrow |
| 24, 44, 64, 84 | application grid |
| —, —, —, 65 | circumferential groove |
| —, —, —, 66 | radial bore |
| 27, 47, 67, — | axial groove |
| —, —, —, 87 | helical groove |
| 28, 48, 68, 88 | radial bore |
| 29, 49, 69, 89 | cavity |
| 111, 131 | application head |
| 112, 132 | housing |
| 113, 133 | cylinder control slide |
| 114, 134 | journal |
| 115, 135 | slotted nozzle |
| 116, 136 | control slide chamber |
| 117, 137 | nozzle slot |
| 118, 138 | surface groove |
| 119 | attaching muff |
| 120, 140 | width of material |
| —, 141 | cavity |
| —, 142 | axial bore |
| —, 143 | radial bore |

1. An application head (11, 31, 51, 71) for the contact-free application of liquid media such as thermoplastic plastics or melted hot-melt adhesives to a width of material (22, 42, 62, 82) which is movable relative to the application head, having a housing (12, 32, 52, 72), having a control slide chamber (20, 40, 60, 80) in the housing, in which control slide chamber a cylinder control slide (13, 33, 53, 73) is supported so as to be rotatingly drivable, having at least one supply aperture for introducing a medium into the control slide chamber (20, 40, 60, 80), and having a slotted nozzle (18, 38, 58, 78) for releasing the medium, which slotted nozzle is controllable by the cylinder control slide (13, 33, 53, 73) and extends transversely to the direction of movement of the width of material,
characterised in
that the cylinder control slide (13, 33, 53, 73) has the following characteristics:
an inner cavity (29, 49, 69, 89) which can be supplied with medium through the supply aperture,
a cylindrical surface which can seal the slotted nozzle (18, 38, 58, 78) from the inside,
surface grooves (27, 47, 67, 87) in the cylindrical surface which, as a function of their rotational positions, are able to communicate with the slotted nozzle, and
radial exit bores (28, 48, 68, 88) extending from the inner cavity into the surface grooves.

2. An application head according to claim 1,
characterised in
that the slotted nozzle (18, 38, 58, 78) comprises a nozzle through-slot.

3. An application head according to any one of claims 1 or 2,
characterised in
that the slotted nozzle (18, 38, 58) comprises a plurality of nozzle holes which adjoin one another and which, in particular, are formed by a orifice plate with individual grooves or individual bores.

4. An application head according to any one of claims 1 to 3,
characterised in
that the surface grooves (27, 47, 67) comprise a plurality of axis-parallel grooves.

5. An application head according to any one of claims 1 to 3,
characterised in
that the surface grooves (87) comprise at least one helical or spiral-shaped groove.

6. An application head according to any one of claims 1 to 5,
characterised in
that the cylinder control slide (13, 33, 73) comprises at least one journal (15, 35, 75) which axially projects from the housing and in which there is provided an axial bore (16, 36, 76) which is connected to the inner cavity (29, 49, 89) and serves as a supply aperture.

7. An application head according to any one of claims 1 to 5,
characterised in
that at at least one end of the housing (52), there is provided a bore (56) in the housing and an annular channel between the cylinder control slide (53) and the control slide chamber (60), which is connected to the bore in the housing, and
that radial supply bores (66) are provided in the cylinder control slide (53) in the plane of the annular channel, which are connected to the inner cavity (69) and serve as supply apertures.

8. An application head according to claim 7,
characterised in
that the annular channel is formed by an annular groove in the control slide chamber surface.

9. An application head according to claim 7,
characterised in
that the annular channel is formed by a circumferential groove (65) in the cylinder control slide (53).

10. An application head according to claim 4,
characterised in
that the diameter of the radial exit bores (28, 48, 68) leading into the axis-parallel surface grooves (27, 47, 67) increases with the distance from the at least one supply aperture.

11. An application head according to any one of claims 1 to 10,
characterised in
that the control slide chamber (20, 40, 60, 80) is cylindrical and encloses the cylinder control slide (13, 33, 53, 73) substantially sealingly.

12. An application head according to any one of claims 1 to 11,
characterised in
that the at least one supply aperture is sealed by shaft seals relative to the cylinder control slide region provided with surface grooves.

13. An application head (111, 131) for the contact-free application of liquid media such as thermoplastic plastics or melted hot-melt adhesives to a width of material (120, 140) which is movable relative to the application head, having a housing (112, 132), having a control slide chamber (116, 136) in the housing, in which control slide chamber a cylinder control slide (113, 133) is supported so as to be rotatingly drivable, having at least one supply aperture (119, 142) for introducing a medium into the control slide chamber (116, 136), and having a slotted nozzle (115, 135) for releasing the medium, which slotted nozzle is controllable by the cylinder control slide (113, 133) and extends transversely to the direction of movement of the width of material,
characterised in
that the cylinder control slide (113, 133) has the following characteristics:
a cylindrical surface which can seal the slotted nozzle (115, 135) from the inside,
at least one helical or spiral-shaped surface groove (118, 138) in the cylindrical surface which, as function of its rotational position, in certain portions, is able to communicate with the slotted nozzle (115, 135), as well as
a storage volume for medium inside the control slide chamber (116, 136), which storage volume communicates with the at least one surface groove (118, 138).

14. An application head according to claim 13,
characterised in
that the control slide chamber (116), in at least one circumferential region, is widened relative to the cross-section of the cylinder control slide (113) and that the widened cavity between the wall of the control slide chamber (116) and the surface of the cylinder control slide (113) forms the storage volume.

15. An application head according to claim 13,
characterised in
that the cylinder control slide (133) comprises an inner cavity (141) which forms the storage volume and that the control slide chamber (136) surrounds the cylinder control slide (133) substantially sealingly with a cylindrical surface, with radial bores (143) leading from the inner cavity (141) into the surface groove (138).

16. An application head according to claim 14,
characterised in
that at least one housing bore (119) is connected to the inside of the control slide chamber (116) which forms the supply aperture.

17. An application head according to claim 15,
characterised in
that the cylinder control slide (133) comprises at least one journal (134) which projects from the housing (132) and which is provided with an axial bore (142) which forms the supply aperture leading to the inner cavity (141) of the cylinder control slide (133).

18. An application head according to claim 15,
characterised in
that at least one housing bore is connected to the annular channel between the control slide chamber and the cylinder control slide and that radial bores, starting from the annular channel, lead into the inside of the cylinder control slide and form the at least one supply aperture leading to the inner cavity of the cylinder control slide (without Figure).
